(19) United States
(12) Patent Application Publication
(10) Pub. No.: US 2025/0192140 A1
(43) Pub. Date: Jun. 12, 2025

(54) POSITIVE ELECTRODE FOR NON-AQUEOUS ELECTROLYTE SECONDARY BATTERY, NON-AQUEOUS ELECTROLYTE SECONDARY BATTERY USING SAME, BATTERY MODULE, AND BATTERY SYSTEM

(71) Applicant: SEKISUI CHEMICAL CO., LTD., Osaka (JP)

(72) Inventors: Hikaru YOSHIKAWA, Tsukuba-shi (JP); Taro MOMOZAKI, Tsukuba-shi (JP); Yuichi SABI, Tsukuba-shi (JP)

(73) Assignee: SEKISUI CHEMICAL CO., LTD., Osaka (JP)

(21) Appl. No.: 18/846,070

(22) PCT Filed: Mar. 16, 2023
(86) PCT No.: PCT/JP2023/010328

§ 371 Date: Sep. 11, 2024

(30) Foreign Application Priority Data
Mar. 16, 2022 (JP) 2022-041372

(51) Int. Cl. H01M 4/131; H01M 4/02; H01M 4/36; H01M 4/58; H01M 4/62; H01M 10/0525

(52) U.S. Cl. CPC H01M 4/131; H01M 4/366; H01M 4/5825; H01M 4/625; H01M 10/0525; H01M 2004/021; H01M 2004/028

(57) ABSTRACT

The present invention relates to a positive electrode (1), comprising a positive electrode current collector metal body (14) and a composite laminate (16) present on at least one surface of the positive electrode current collector metal body (14), wherein: the composite laminate (16) comprises a positive electrode active material layer (12) and a conductive layer (15), wherein the conductive layer (15) is present between the positive electrode current collector metal body (14) and the positive electrode active material layer (12), and coats at least a part of the positive electrode current collector metal body (14), the conductive layer (15) comprises conductive carbon, the positive electrode active material layer (12) comprises one or more positive electrode active material particles, at least a part of the positive electrode active material particles comprises a core section consisting of a positive electrode active material and an active material coating section coating at least a part of a surface of the core section, the conductive layer (15) comprises conductive carbon, a total conductive carbon content of the composite laminate (16) is 0.5 to 3.0% by mass with respect to a total mass of the composite laminate (16), and a volume capacity density of the composite laminate (16) is 330 to 400 mAh/cm³.

### TECHNICAL FIELD

The present invention relates to a positive electrode for non-aqueous electrolyte secondary battery, as well as a non-aqueous electrolyte secondary battery, a battery module, and a battery system, each using the positive electrode.

Priority is claimed on Japanese Patent Application No. 2022-041372, filed Mar. 16, 2022, the contents of which are incorporated herein by reference.

### BACKGROUND ART

A non-aqueous electrolyte secondary battery is generally composed of a positive electrode, a non-aqueous electrolyte, a negative electrode, and a separation membrane (hereinafter, also referred to as “separator”) installed between the positive electrode and the negative electrode.

A conventionally known positive electrode for a non-aqueous electrolyte secondary battery is formed by fixing a composition composed of a positive electrode active material containing lithium ions, a conducting agent, and a binder to the surface of a metal foil as a current collector.

Examples of the practically used positive electrode active material containing lithium ions include lithium transition metal composite oxides such as lithium cobalt oxide, lithium nickel oxide, and lithium manganese oxide, and lithium phosphate compounds such as lithium iron phosphate.

Patent Document 1 proposes a non-aqueous electrolyte secondary battery having a positive electrode containing spherical LiNiO₂ particles obtained by a specific production method. According to the invention recited in Patent Document 1, an improvement in battery capacity is achieved.

### PRIOR ART DOCUMENT

### Patent Document

Patent Document 1: Japanese Patent Granted Publication No. 3434873

### SUMMARY OF THE INVENTION

### Problems to be Solved by the Invention

However, there is a demand for improved cycle characteristics for non-aqueous electrolyte secondary batteries.

The present invention provides a positive electrode for a non-aqueous electrolyte secondary battery, which can improve the cycle characteristics of a non-aqueous electrolyte secondary battery.

### Means for Solving the Problems

The embodiments of the present invention are as follows.

<1>

A positive electrode for a non-aqueous electrolyte secondary battery, including a positive electrode current collector metal body and a composite laminate present on at least one surface of the positive electrode current collector metal body, in which
the composite laminate includes a positive electrode active material layer and a conductive layer, in which the conductive layer is present between the positive electrode current collector metal body and the positive electrode active material layer, and coats at least a part of the positive electrode current collector metal body,
the conductive layer includes conductive carbon,
the positive electrode active material layer includes one or more positive electrode active material particles,
at least a part of the positive electrode active material particles includes a core section consisting of a positive electrode active material and an active material coating section coating at least a part of a surface of the core section,
the active material coating section includes conductive carbon,
a total conductive carbon content of the composite laminate is 0.5 to 3.0% by mass, 0.7 to 2.9% by mass, or 0.9 to 2.6% by mass with respect to a total mass of the composite laminate, and
a volume capacity density of the composite laminate is 330 to 400 mAh/cm³, 340 to 390 mAh/cm³, or 350 to 380 mAh/cm³.
   <2>

The positive electrode according to <1>, in which the positive electrode active material includes a compound represented by a formula LiFeₓM₍₁₋ₓ₎PO₄, wherein 0≤x≤1, M is Co, Ni, Mn, Al, Ti or Zr.

<3>

The positive electrode according to <1> or <2>, in which a volume density of the composite laminate is 2.2 to 2.7 g/cm³, 2.25 to 2.60 g/cm³, or 2.30 to 2.50 g/cm³.

<4>

A positive electrode for a non-aqueous electrolyte secondary battery, including a positive electrode current collector metal body and a composite laminate present on at least one surface of the positive electrode current collector metal body, in which:
the composite laminate includes a positive electrode active material layer and a conductive layer, in which the conductive layer is present between the positive electrode current collector metal body and the positive electrode active material layer, and coats at least a part of the positive electrode current collector metal body,
the conductive layer includes conductive carbon,
the positive electrode active material layer includes one or more positive electrode active material particles,
at least a part of the positive electrode active material particles includes a core section consisting of a positive electrode active material and an active material coating section coating at least a part of a surface of the core section,
the active material coating section includes conductive carbon,
a total conductive carbon content of the composite laminate is 0.5 to 2.6% by mass with respect to a total mass of the composite laminate,
a volume capacity density of the composite laminate is 330 to 345 mAh/cm³, and
a volume density of the composite laminate is 2.20 g/cm³ or more and less than 2.30 g/cm³.
   <5>

A non-aqueous electrolyte secondary battery, including the positive electrode of any one of <1> to <4>, a negative electrode, and a non-aqueous electrolyte disposed between the positive electrode and the negative electrode.

<6>

A battery module or battery system including a plurality of the non-aqueous electrolyte secondary batteries of <5>.

### Effect of the Invention

According to the present invention, the cycle characteristics of a non-aqueous electrolyte secondary battery can be improved.

### BRIEF DESCRIPTION OF THE DRAWINGS

FIG. 1 is a cross-sectional view schematically showing an example of a positive electrode for a non-aqueous electrolyte secondary battery according to the present invention.

FIG. 2 is a cross-sectional view of a coin cell used in the method for measuring the volume capacity density.

FIG. 3 is a cross-sectional view schematically showing an example of a non-aqueous electrolyte secondary battery according to the present invention.

### EMBODIMENTS TO CARRY OUT THE INVENTION

In the present specification and claims, “to” indicating a numerical range means that the numerical values described before and after “to” are included as the lower limit and the upper limit of the range.

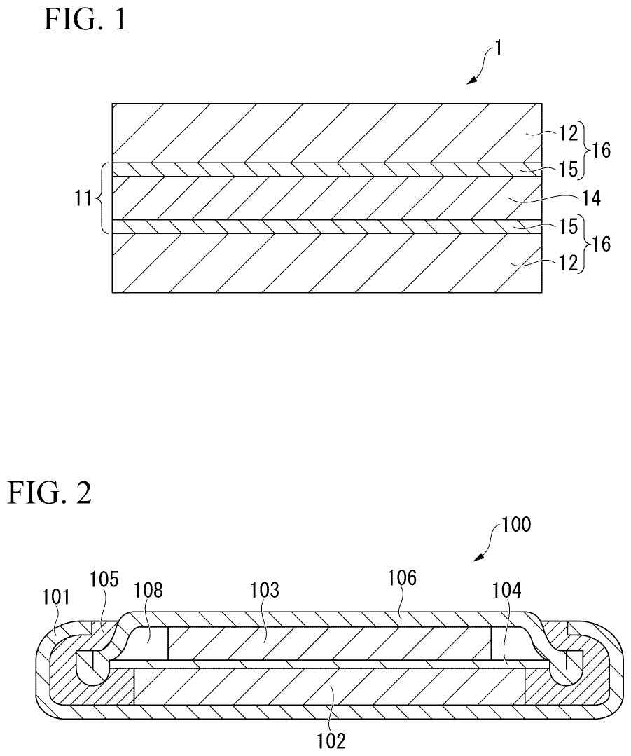

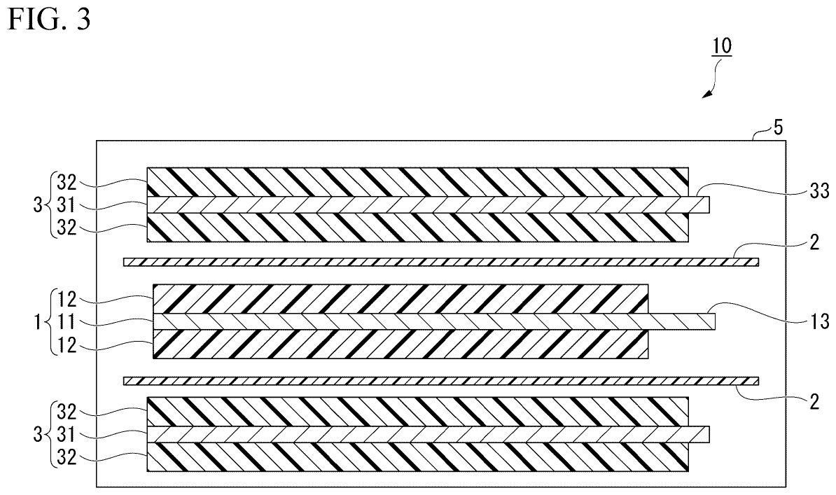

FIG. 1 is a schematic cross-sectional view showing one embodiment of a positive electrode for a non-aqueous electrolyte secondary battery according to the present invention. FIG. 3 is a schematic cross-sectional view showing one embodiment of a non-aqueous electrolyte secondary battery according to the present invention.

FIG. 1 to FIG. 3 are schematic diagrams for facilitating the understanding of the configurations, and the dimensional ratios and the like of each component do not 25 necessarily represent the actual ones.

In the present embodiment, the positive electrode for a non-aqueous electrolyte secondary battery (also simply referred to as “positive electrode”) 1 has a positive electrode current collector metal body and a composite laminate.

In the present embodiment, the non-aqueous electrolyte secondary battery has a positive electrode, a negative electrode, and a non-aqueous electrolyte disposed between the positive electrode and the negative electrode.

Hereinbelow, the present invention is described with reference to embodiments.

### (Positive Electrode for Non-Aqueous Electrolyte Secondary Battery)

The positive electrode 1 of the present embodiment has a positive electrode current collector metal body 14 and a composite laminate 16.

In FIG. 1, the composite laminate 16 is present on both sides of the positive electrode current collector metal body 14. The composite laminate 16 may be present on only one side of the positive electrode current collector metal body 14. That is, the composite laminate 16 is present on at least one surface of the positive electrode current collecting metal body 14.

The composite laminate 16 has a positive electrode active material layer 12 and a conductive layer 15. The conductive layer 15 is present between the positive electrode current collector metal body 14 and the positive electrode active material layer 12. The conductive layer 15 coats at least a part of the surface of the positive electrode current collector metal body 14. The conductive layer 15 is a conductive coating layer that coats a part or all of the surface of the positive electrode current collector metal body 14. In FIG. 1, the conductive layer 15 is present on both sides of the positive electrode current collector metal body 14, however, the conductive layer 15 may be present on only one side of the positive electrode current collector metal body 14.

In the present specification, the positive electrode current collector metal body 14 and the conductive layer 15 may be collectively referred to as the positive electrode current collector 11.

### <Composite Laminate>

The composite laminate 16 includes a positive electrode current collector metal body 14, a conductive layer 15, and a positive electrode active material layer 12, in this order.

### <<Positive Electrode Active Material Layer>>

The positive electrode active material layer 12 includes one or more positive electrode active material particles.

The positive electrode active material layer 12 preferably further includes a binder.

The positive electrode active material layer 12 may further include a conducting agent. In the context of the present specification, the term “conducting agent” refers to a conductive material of a particulate shape, a fibrous shape, etc., which is mixed with the positive electrode active material for the preparation of the positive electrode active material layer or formed in the positive electrode active material layer, and is caused to be present in the positive electrode active material layer in a form connecting the particles of the positive electrode active material. The conducting agent exists independently of the positive electrode active material particles.

The positive electrode active material layer 12 may further include a dispersant.

The amount of the positive electrode active material particles is preferably 80.0 to 99.9% by mass, and more preferably 90 to 99.5% by mass, based on the total mass of the positive electrode active material layer 12.

The thickness of the positive electrode active material layer is preferably 30 to 500 μm, more preferably 40 to 400 μm, and particularly preferably 50 to 300 μm. When the thickness of the positive electrode active material layer is not less than the lower limit value of the above range, the energy density of a battery with the positive electrode incorporated therein tends to improve. When the thickness is not more than the upper limit value of the above range, the peel strength of the positive electrode active material layer can be improved, thereby preventing delamination of the positive electrode active material layer during charging/discharging. When the positive electrode active material layers are present on both sides of the positive electrode current collector, the thickness of the positive electrode active material layer is the total thickness of the two layers located on both sides.

### [Positive Electrode Active Material Particles]

The positive electrode active material particles include a positive electrode active material. At least a part of the positive electrode active material particles is a coated particle.

In the coated particles, a coating section containing a conductive material (hereinafter, also referred to as “active material coating section”) is present on the surfaces of the positive electrode active material particles. The active material coating section of the active material particles enables the positive electrode active material particles to further enhance the battery capacity and cycling performance.

For example, the active material coating section is formed in advance on the surface of the positive electrode active material particles, and is present on the surface of the positive electrode active material particles in the positive electrode active material layer. That is, the active material coating section in the present specification is not one newly formed in the steps following the preparation step of a positive electrode composition. In addition, the active material coating section is not one that easily comes off in the steps following the preparation step of a positive electrode composition.

For example, the active material coating section stays on the surface of the positive electrode active material even when the coated particles are mixed with a solvent by a mixer or the like during the preparation of a positive electrode composition. Further, the active material coating section stays on the surface of the positive electrode active material even when the positive electrode active material layer is detached from the positive electrode and then put into a solvent to dissolve the binder contained in the positive electrode active material layer in the solvent. Furthermore, the active material coating section stays on the surface of the positive electrode active material even when an operation to disintegrate agglomerated particles is implemented for measuring the particle size distribution of the particles in the positive electrode active material layer by the laser diffraction scattering method.

The active material coating section preferably coats 50% or more, preferably 70% or more, and more preferably 90% or more of the total area of the entire outer surfaces of the positive electrode active material particles.

That is, the coated particles have a core section that is a positive electrode active material and an active material coating section that coats the surface of the core section, and the area ratio (i.e., coverage) of the active material coating section with respect to the surface area of the core section is preferably 50% or more, more preferably 70% or more, and even more preferably 90% or more. The upper limit of the coverage is not particularly limited, but for example, preferably 94% or less, more preferably 97% or less, even more preferably 100% or less. The coverage is preferably 50 to 94%, more preferably 70 to 97%, and even more preferably 90 to 100%.

Examples of the method for producing the coated particles include a vapor deposition method and a sintering method.

Examples of the sintering method include a method that sinters an active material composition containing the positive electrode active material particles and an organic substance at 500 to 1000° C. for 1 to 100 hours under atmospheric pressure. Examples of the organic substance added to the active material composition include salicylic acid, catechol, hydroquinone, resorcinol, pyrogallol, fluoroglucinol, hexahydroxybenzene, benzoic acid, phthalic acid, terephthalic acid, phenylalanine, water dispersible phenolic resins, sucrose, glucose, lactose, malic acid, citric acid, allyl alcohol, propargyl alcohol, ascorbic acid, and polyvinyl alcohol. With respect to these substances, a mixture of two or more kinds may be used, and an organic substance other than those listed above may also be used. This sintering method sinters an active material composition to allow carbon in the organic material to be fused to the surface of the positive electrode active material to thereby form the active material coating section.

Another example of the sintering method is the so-called impact sintering coating method.

The impact sintering coating method is carried out, for example, as follows. In an impact sintering coating device, a burner is ignited using a mixture of hydrocarbon fuel and oxygen, and a flame is generated by burning the mixture in a combustion chamber. In this process, the amount of oxygen is reduced to an amount equivalent to complete combustion of the fuel or less to lower the flame temperature. A powder supply nozzle is installed behind the flame, and a solid-liquid-gas three-phase mixture consisting of a solution obtained by dissolving an organic matter for coating in a solvent, and a combustion gas is sprayed from the powder supply nozzle. By increasing the amount of combustion gas maintained at room temperature, the temperature of the sprayed fine powder is lowered, and the sprayed fine powder is accelerated at a temperature below the transformation temperature, sublimation temperature or evaporation temperature of the powder material, and is instantly sintered by impact to coat the positive electrode active material particles.

Examples of the vapor deposition method include a vapor phase deposition method such as a physical vapor deposition method and a chemical vapor deposition method, and a liquid phase deposition method such as plating.

The coverage can be measured by a method as follows. First, the particles in the positive electrode active material layer are analyzed by the energy dispersive X-ray spectroscopy (TEM-EDX) using a transmission electron microscope. Specifically, an elemental analysis is performed by EDX with respect to the outer peripheral portion of the positive electrode active material particles in a TEM image.

The elemental analysis is performed on carbon to identify the carbon coating the positive electrode active material particles. A section with a carbon coating having a thickness of 1 nm or more is defined as a coating section, and the ratio of the coating section to the entire circumference of the observed positive electrode active material particle can be determined as the coverage. The measurement can be performed with respect to, for example, 10 positive electrode active material particles, and an average value thereof can be used as a value of the coverage.

Further, the active material coating section is a layer directly formed on the surface of particles (core section) composed of only the positive electrode active material, which has a thickness of 1 nm to 100 nm, and preferably 5 nm to 50 nm. This thickness can be determined by the above-mentioned TEM-EDX used for the measurement of the coverage.

With respect to the coverage of the positive electrode active material particles, the determination can also be implemented by calculation from TEM-EDX elemental mapping of particles with elements specific to the positive electrode active material and elements specific to the conductive material in the active material coating section of the active material. Similarly, a ratio of the active material coating section to the entire circumference of the observed positive electrode active material particle may be determined as the coverage, with the coating being defined as at least 1 nm-thick portion of the element specific to the conductive material. The measurement can be performed with respect to, for example, 10 positive electrode active material particles, and an average value thereof can be used as a value of the coverage.

The coverage of the coated particles in the present embodiment is particularly preferably 100%.

This coverage is an average value for all the positive electrode active material particles present in the positive electrode active material layer. As long as this average value is not less than the above lower limit value, the positive electrode active material layer may contain positive electrode active material particles without the active material coating section. When the positive electrode active material particles (hereinafter, also referred to as “single particles”) without the active material coating section are present in the positive electrode active material layer, the amount thereof is preferably 30% by mass or less, more preferably 20% by mass or less, and particularly preferably 10% by mass or less, with respect to the total mass of the positive electrode active material particles present in the positive electrode active material layer. When single particles are present in the positive electrode active material layer, the lower limit of the amount of single particles relative to the total amount of positive electrode active material particles is not particularly limited, but may be 0.1% by mass or more, 0.2% by mass or more, or 0.3% by mass or more. When single particles are present in the positive electrode active material layer, the amount of single particles relative to the total amount of positive electrode active material particles is preferably 0.3 to 30% by mass, more preferably 0.2 to 20% by mass, and even more preferably 0.1 to 10% by mass. In one embodiment, it is preferred that single particles are not present in the positive electrode active material layer.

The conductive material of the active material coating section contains carbon (i.e., conductive carbon). The conductive material may be composed only of carbon, or may be a conductive organic compound containing carbon and elements other than carbon. Examples of the other elements include nitrogen, hydrogen, oxygen and the like. In the conductive organic compound, the amount of the other elements is preferably 10 atomic % or less, and more preferably 5 atomic % or less.

It is more preferable that the conductive material in the active material coating section is composed only of carbon.

The amount of the conductive material is preferably 0.1 to 4.0% by mass, more preferably 0.5 to 3.0% by mass, and even more preferably 0.7 to 2.5% by mass, with respect to the total mass of the positive electrode active material particles having the active material coating portion. Excessive amount of the conductive material is not favorable in that the conductive material may come off the surface of the positive electrode active material particles and remain as isolated conducting agent particles.

Conductive particles that do not contribute to the creation of conductive path may become a site where self-discharge of the battery starts or a cause of undesirable side reactions.

The positive electrode active material particles preferably contain a compound having an olivine crystal structure.

The compound having an olivine crystal structure is preferably a compound represented by the following formula: LiFeₓM₍₁₋ₓ₎PO₄ (hereinafter, also referred to as “formula (I)”). In the formula (I), 0≤x≤1. M is Co, Ni, Mn, Al, Ti or Zr. A minute amount of Fe and M (Co, Ni, Mn, Al, Ti or Zr) may be replaced with another element so long as the replacement does not affect the physical properties of the compound. The presence of a trace amount of metal impurities in the compound represented by the formula (I) does not impair the effect of the present invention.

The compound represented by the formula (I) is preferably lithium iron phosphate represented by LiFePO₄ (hereinafter, also referred to as “lithium iron phosphate”).

The positive electrode active material particles are more preferably lithium iron phosphate particles having, on at least a part of their surfaces, an active material coating section including a conductive material (hereinafter, also referred to as “coated lithium iron phosphate particles”). It is more preferable that the entire surface of lithium iron phosphate particles is coated with a conductive material for achieving more excellent battery capacity and cycling performance.

The coated lithium iron phosphate particles can be produced by a known method.

For example, the coated lithium iron phosphate particles can be obtained by a method in which a lithium iron phosphate powder is prepared by following the procedure described in Japanese Patent No. 5098146, and at least a part of the surface of lithium iron phosphate particles in the powder is coated with carbon by following the procedure described in G S Yuasa Technical Report, June 2008, Vol. 5, No. 1, pp. 27-31 and the like.

Specifically, first, iron oxalate dihydrate, ammonium dihydrogen phosphate, and lithium carbonate are weighed to give a specific molar ratio, and these are pulverized and mixed in an inert atmosphere. Next, the obtained mixture is heat-treated in a nitrogen atmosphere to prepare a lithium iron phosphate powder.

Then, the lithium iron phosphate powder is placed in a rotary kiln and heat-treated while supplying methanol vapor with nitrogen as a carrier gas to obtain a powder of lithium iron phosphate particles having at least a part of their surfaces coated with carbon.

For example, the particle size of the lithium iron phosphate particles can be adjusted by optimizing the crushing time in the crushing process. The amount of carbon coating the particles of the lithium iron phosphate particles can be adjusted by optimizing the heating time and temperature in the step of implementing heat treatment while supplying methanol vapor. It is desirable to remove the carbon particles not consumed for coating by subsequent steps such as classification and washing.

The positive electrode active material particles may include at least one type of other positive electrode active material particles including other positive electrode active materials than the compound having an olivine type crystal structure.

Preferable examples of the other positive electrode active materials include a lithium transition metal composite oxide. Specific examples thereof include lithium cobalt oxide, lithium nickel oxide, lithium nickel cobalt aluminum oxide (LiNiₓCo_{y}Al_{z}O₂ with the proviso that x+y+z=1), lithium nickel cobalt manganese oxide (LiNiₓCo_{y}Mn₂O₂ with the proviso that x+y+z=1), lithium manganese oxide, lithium manganese cobalt oxide, lithium manganese chromium oxide, lithium vanadium nickel oxide, nickel-substituted lithium manganese oxide (e.g., LiMn_{1.5}Ni_{0.5}O₄), and lithium vanadium cobalt oxide, as well as nonstoichiometric compounds formed by partially substituting the compounds listed above with metal elements. Examples of the metal element include one or more selected from the group consisting of Mn, Mg, Ni, Co, Cu, Zn and Ge.

The other positive electrode active material particles may have, on at least a part of surfaces thereof, the active material coating section described above.

The amount of the compound having an olivine type crystal structure is preferably 50% by mass or more, more preferably 80% by mass or more, and even more preferably 90% by mass or more, based on the total mass of the positive electrode active material particles. This amount may be 100% by mass. The amount of the compound having an olivine type crystal structure is preferably 50 to 100% by mass or more, more preferably 80 to 100% by mass or more, and even more preferably 90 to 100% by mass or more, based on the total mass of the positive electrode active material particles. When the positive electrode active material particles have the active material coating section, the total mass of the positive electrode active material particles includes the mass of the active material coating section.

When the coated lithium iron phosphate particles are used, the amount of the coated lithium iron phosphate particles is preferably 50% by mass or more, more preferably 80% by mass or more, and even more preferably 90% by mass or more, based on the total mass of the positive electrode active material particles. This amount may be 100% by mass. When the coated lithium iron phosphate particles are used, the amount of the coated lithium iron phosphate particles is preferably 50 to 100% by mass or more, more preferably 80 to 100% by mass or more, and even more preferably 90 to 100% by mass or more, based on the total mass of the positive electrode active material particles.

The thickness of the active material coating section of the positive electrode active material particles is preferably 1 to 100 nm.

The thickness of the active material coating section of the positive electrode active material particles can be measured by a method of measuring the thickness of the active material coating section in a transmission electron microscope (TEM) image of the positive electrode active material particles. The thickness of the active material coating sections on the surfaces of the positive electrode active material particles need not be uniform. It is preferable that the positive electrode active material particles have, on at least a part of surfaces thereof, the active material coating section having a thickness of 1 nm or more, and the maximum thickness of the active material coating section is 100 nm or less.

The average particle size of the positive electrode active material particles is preferably 0.1 to 20.0 μm, and more preferably 0.5 to 15.0 μm. When two or more types of positive electrode active material particles are used, the average particle size of each of such positive electrode active material particles may be within the above range. When the positive electrode active material particles have the active material coating section, the average particle size of the positive electrode active material particles includes the thickness of the active material coating section.

When the average particle size is not less than the lower limit value of the above range, the dispersibility in the positive electrode composition is improved, and agglomerates are less likely to occur. On the other hand, when the average particle size is not more than the upper limit value of the above range, the specific surface area becomes appropriately large, making it easier to secure an area for reaction during charging and discharging. As a result, the resistance of the battery decreases, and input/output performance is less likely to deteriorate.

The average particle size of the positive electrode active material particles in the present specification is a volume-based median particle size measured using a laser diffraction/scattering particle size distribution analyzer.

The binder that can be contained in the positive electrode active material layer 12 is an organic substance, and examples thereof include polyacrylic acid, lithium polyacrylate, polyvinylidene fluoride, polyvinylidene fluoride-hexafluoropropylene copolymers, styrene butadiene rubbers, polyvinyl alcohol, polyvinyl acetal, polyethylene oxide, polyethylene glycol, carboxymethyl cellulose, polyacrylic nitrile, and polyimide. With respect to the binder, a single type thereof may be used alone or two or more types thereof may be used in combination.

The amount of the binder with respect to the total mass of the positive electrode active material layer is preferably 1.0% by mass or less, and more preferably 0.8% by mass or less.

When the positive electrode active material layer contains a binder, the lower limit of the amount of the binder with respect to the total mass of the positive electrode active material layer is preferably 0.1% by mass or more, and more preferably 0.3% by mass or more. When the positive electrode active material layer contains a binder, the amount of the binder is preferably 0.1 to 1.0% by mass, and more preferably 0.3 to 0.8% by mass.

### [Conducting Agent]

Examples of the conducting agent contained in the positive electrode active material layer 12 include carbon materials such as graphite, graphene, hard carbon, Ketjen black, acetylene black, and carbon nanotube. With respect to the conducting agent, a single type thereof may be used alone or two or more types thereof may be used in combination.

The amount of the conducting agent in the positive electrode active material layer 12 is, for example, preferably 4 parts by mass or less, more preferably 3 parts by mass or less, and even more preferably 1 part by mass or less, relative to 100 parts by mass of the total mass of the positive electrode active material. It is particularly preferable that the positive electrode active material layer does not contain a conducting agent, and it is desirable that there are no isolated conducting agent particles that do not contribute to the creation of conductive path in the positive electrode active material layer.

Conducting agent particles that do not contribute to the creation of conductive path may become a site where self-discharge of the battery starts or a cause of undesirable side reactions.

When the conducting agent is incorporated into the positive electrode active material layer 12, the lower limit value of the amount of the conducting agent is appropriately determined according to the type of the conducting agent, and is, for example, more than 0.1% by mass, based on the total mass of the positive electrode active material layer 12. When a conducting agent is incorporated into the positive electrode active material layer 12, the amount of the conducting agent is preferably more than 0.1% by mass and 2.5% by mass or less, more preferably more than 0.1% by mass and 2.3% by mass or less, and even more preferably more than 0.1% by mass and 2.0% by mass or less, based on the total mass of the positive electrode active material layer 12.

In the context of the present specification, the expression “the positive electrode active material layer 12 does not contain a conducting agent” or similar expression means that the positive electrode active material layer 12 does not substantially contain a conducting agent, and should not be construed as excluding a case where a conducting agent is contained in such an amount that the effects of the present invention are not affected. For example, if the amount of the conducting agent is 0.1% by mass or less, based on the total mass of the positive electrode active material layer 12, then, it is judged that substantially no conducting agent is contained.

The carbon material used for the conducting agent is bulkier and has a lower apparent density than the conductive carbon that constitutes the active material coating section and the conductive carbon that constitutes the conductive layer 15 described below. For this reason, when the amount of carbon contained in the positive electrode active material layer 12 is the same, the less conducting agent there is in the positive electrode active material layer 12, the smaller the volume of the positive electrode active material layer 12. When the volume of the positive electrode active material layer 12 is reduced, the volume of the composite laminate 16 is reduced, and the capacity per unit volume (hereinafter sometimes referred to as “volume capacity density”) is increased. When the volume capacity density is increased, the resistance in the composite laminate 16 is reduced, and the cycle characteristics are improved.

### [Dispersant]

The dispersant contained in the positive electrode active material layer 12 is an organic substance, and examples thereof include polyvinylpyrrolidone, polyvinyl alcohol, polyvinyl butyral, and polyvinylformal. With respect to these dispersants, a single type thereof may be used individually or two or more types thereof may be used in combination.

The dispersant contributes to improving the dispersibility of the particles in the positive electrode active material layer. On the other hand, when the amount of the dispersant is too high, the resistance is likely to increase.

The amount of the dispersant is preferably 0.5% by mass or less, and more preferably 0.2% by mass or less, based on the total mass of the positive electrode active material layer.

When the positive electrode active material layer contains a dispersant, the lower limit of the amount of the dispersant is preferably 0.01% by mass or more, and more preferably 0.05% by mass or more, based on the total mass of the positive electrode active material layer. When the positive electrode active material layer contains a dispersant, the amount of the dispersant is preferably 0.01 to 0.5% by mass, and more preferably 0.05 to 0.2% by mass.

### <<Conductive Layer>>

The conductive layer 15 is a layer containing carbon (conductive carbon). The conductive layer 15 coats at least a part of the surface of the positive electrode current collector metal body 14. In other words, the conductive layer 15 is provided on at least a part of the surface of the composite laminate 16 that faces the positive electrode current collector metal body 14.

In this context, the expression “at least a part of its surface” means 10% to 100%, preferably 30% to 100%, more preferably 50% to 100% of the area of the surface of the positive electrode current collector metal body.

The conductive material in the conductive layer 15 may contain conductive carbon, and preferably consists of only carbon.

The conductive layer 15 is preferred to be, for example, a coating layer containing carbon particles such as carbon black and a binder. Examples of the binder for the conductive layer 15 include those listed above as examples of the binder for the positive electrode active material layer 12.

The amount of the conductive carbon in the conductive layer 15 is preferably 50 to 90% by mass, more preferably 55 to 85% by mass, and even more preferably 60 to 90% by mass with respect to the total mass of the conductive layer 15.

Examples of a method for providing the conductive layer 15 include a method in which a composition containing a conductive material, a binder, and a solvent is applied to the surface of the positive electrode collector metal body 14 using a known coating method such as a gravure method, and then dried to remove the solvent.

The thickness of the conductive layer 15 is preferably 0.1 to 4.0 μm, more preferably 0.2 to 3.0 μm, and even more preferably 0.3 to 2.0 μm.

The thickness of the conductive layer can be measured by a method that measures the thickness of the coating layer in a transmission electron microscope (TEM) image or a scanning electron microscope (SEM) image of a cross section of the conductive layer. The thickness of the conductive layer need not be uniform. It is preferable that the conductive layer 15 having a thickness of 0.1 μm or more is present on at least a part of the surface of the positive electrode current collector metal body 14, and the maximum thickness of the conductive layer is 4.0 μm or less.

### <Positive Electrode Current Collector Metal Body>

The positive electrode current collector metal body 14 is formed of a metal material. Examples of the metal material include conductive metals such as copper, aluminum, titanium, nickel, and stainless steel.

The positive electrode current collector metal body 14 is a foil made of a metal material, that is, a metal foil, and may include an oxide film formed on the surface.

The thickness of the positive electrode current collector metal body 14 is preferably, for example, 8 to 40 μm, and more preferably 10 to 25 μm.

The thickness of the positive electrode current collector metal body 14 can be measured using a micrometer. One example of the measuring instrument usable for this purpose is an instrument with the product name “MDH-25M”, manufactured by Mitutoyo Co., Ltd.

### <Amount of Conductive Carbon>

In the present embodiment, the positive electrode active material layer 12 and the conducting layer 15 contain conductive carbon. That is, the composite laminate 16 contains conductive carbon.

The amount of the conductive carbon is preferably 0.5% by mass or more and less than 3.0 by mass, more preferably 1.0 to 2.8% by mass, and even more preferably 1.2 to 2.6% by mass, based on the total mass of the positive electrode active material layer 12.

When the amount of the conductive carbon in the positive electrode active material layer 12 is not less than the lower limit value of the above range, the amount is sufficient to form a conductive path in the positive electrode active material layer 12, and the cycle characteristics are improved. When the amount of the conductive carbon in the positive electrode active material layer 12 is not more than the upper limit value, the volume capacity density can be increased, and the cycle characteristics can be further improved.

The amount of the conductive carbon with respect to the total mass of the positive electrode active material layer can be calculated from the amount of the conductive carbon of the positive electrode active material particles and the conducting agent as well as the blended amount.

The amount of the conductive carbon based the total mass of the positive electrode active material layer 12 can be measured by <<Method for measuring amount of conductive carbon>> described below with respect to a dried product, for example, a powder, as a measurement target, obtained by vacuum-drying at 120° C., the positive electrode active material layer 12 detached from the positive electrode.

For example, the measurement target may be one obtained by detaching the outermost surface of the positive electrode active material layer with a depth of several μm using a spatula or the like, and vacuum drying the resulting at 120° C.

The amount of the conductive carbon to be measured by the <<Method for measuring amount of conductive carbon>> described below includes carbon in the active material coating section and carbon in the conducting agent, and does not include carbon in the binder or carbon in the dispersant.

The amount of conductive carbon with respect to the total mass of the composite laminate 16, i.e., the total amount of conductive carbon in the positive electrode active material layer 12 and the conductive layer 15, is 0.5 to 3.0% by mass, preferably 0.7 to 2.9% by mass, more preferably 0.9 to 2.8% by mass, and even more preferably 1.2 to 2.7% by mass.

When the amount of the conductive carbon in the composite laminate 16 is not less than the lower limit value of the above range, the amount is sufficient to form a conductive path in the composite laminate 16, and the cycle characteristics are improved. When the amount of the conductive carbon in the composite laminate 16 is not more than the upper limit value, the volume capacity density can be increased, and the output and the cycle characteristics can be further improved.

The amount of the conductive carbon based the total mass of the composite laminate 16 can be measured by <<Method for measuring amount of conductive carbon>> described below with respect to a dried product, for example, a powder, as a measurement target, obtained by vacuum-drying at 120° C., the remaining portion obtained by detaching only the positive electrode current collector metal body 14 from the positive electrode.

For example, in the measurement of the amount of the conductive carbon in the composite laminate 16, pure water is allowed to impregnate into the composite laminate 16, then the positive electrode current collector metal body 14 is detached using a spatula or the like, and the remaining portion is vacuum dried at 120° C., and the resulting product can be used as the measurement target.

The amount of the conductive carbon to be measured by the <<Method for measuring amount of conductive carbon >> described below includes carbon in the active material coating section, carbon in the conducting agent, and carbon in the conductive layer, and does not include carbon in the binder or carbon in the dispersant.

### <<Method for Measuring Amount of Conductive Carbon>>

### [Measurement Method A]

A sample having a weight w1 is taken from a homogeneously mixed product of the measurement target, and the sample is subjected to thermogravimetry differential thermal analysis (TG-DTA) implemented by following steps A1 and A2 defined below, to obtain a TG curve. From the obtained TG curve, the following first weight loss amount M1 (unit: % by mass) and second weight loss amount M2 (unit: % by mass) are obtained. By subtracting M1 from M2, the amount of the conductive carbon (unit: % by mass) is obtained.

Step A1: The temperature of the sample is raised from 30° C. to 600° C. at a heating rate of 10° C./min and the temperature is held at 600° C. for 10 minutes in an argon gas stream of 300 mL/min to measure a resulting mass w2 of the sample, from which a first weight loss amount M1 is determined by formula (a1):

$$M 1 = ( w 1 - w 2 ) / w 1 \times 100 \qquad ( a1 )$$

Step A2: Immediately after the step A1, the temperature is lowered from 600° C. to 200° C. at a cooling rate of 10° C./min and held at 200° C. for 10 minutes, followed by completely substituting the argon gas stream with an oxygen gas stream. The temperature is raised from 200° C. to 1000° C. at a heating rate of 10° C./min and held at 1000° C. for 10 minutes in an oxygen gas stream of 100 mL/min to measure a resulting mass w3 of the sample, from which a second weight loss amount M2 (unit: % by mass) is determined by formula (a2):

$$M 2 = ( w 1 - w 3 ) / w 1 \times 100 \qquad ( a2 )$$

### [Measurement Method B]

0.0001 mg of a precisely weighed sample is taken from a homogeneously mixed product of the measurement target, and the sample is burnt under burning conditions defined below to measure an amount of generated carbon dioxide by a CHN elemental analyzer, from which a total carbon amount M3 (unit: % by mass) of the sample is determined. Also, a first weight loss amount M1 is determined following the procedure of the step A1 of the measurement method A. By subtracting M1 from M3, the amount of conductive carbon (unit: % by mass) is obtained.

### [Burning Conditions]

Temperature of combustion furnace: 1150° C.
Temperature of reduction furnace: 850° C.
Helium flow rate: 200 mL/min.
Oxygen flow rate: 25 to 30 mL/min.

### [Measurement Method C]

The total carbon amount M3 (unit: % by mass) of the sample is measured in the same manner as in the above measurement method B. Further, the carbon amount M4 (unit: % by mass) of carbon derived from the binder is determined by the following method. M4 is subtracted from M3 to determine the amount of the conductive carbon (unit: % by mass).

When the binder is polyvinylidene fluoride (PVDF: monomer (CH₂CF₂), molecular weight 64), the amount of conductive carbon content can be calculated by the following formula from the fluoride ion (F) amount (unit: % by mass) measured by combustion ion chromatography based on the tube combustion method, the atomic weight (19) of fluorine in the monomers constituting PVDF, and the atomic weight (12) of carbon constituting PVDF.

PVDF amount (unit: % by mass)=fluoride ion amount (unit: % by mass)×64/38

PVDF-derived carbon amount M4 (unit: % by mass)=fluoride ion amount (unit: % by mass)×12/19

The presence of polyvinylidene fluoride as a binder can be verified by a method in which a sample or a liquid obtained by extracting a sample with an N,N-dimethylformamide solvent is subjected to Fourier transform infrared spectroscopy to confirm the absorption attributable to the C—F bond. Such verification can be likewise implemented by fluorine nucleus nuclear magnetic resonance spectroscopy (¹⁹F-NMR).

When the binder is identified as being other than PVDF, the carbon amount M4 attributable to the binder can be calculated by determining the amount (unit: % by mass) of the binder from the measured molecular weight, and the carbon amount (unit: % by mass).

When the dispersant is contained, the amount of the conductive carbon (unit: % by mass) can be obtained by subtracting M4 from M3, and further subtracting therefrom the amount of carbon belonging to the dispersant.

These methods are described in the following publications:
Toray Research Center, The TRC News No. 117 (September 2013), pp. 34-37, [Searched on Feb. 10, 2021], Internet <https://www.toray-research.co.jp/technical-info/trcnews/pdf/TRC117 (34-37).pdf >
TOSOH Analysis and Research Center Co., Ltd., Technical Report No. T1019 2017.09.20, [Searched on Feb. 10, 2021], Internet <http://www.tosoh-arc.co.jp/techrepo/files/tarc00522/T1719N.pdf>

### <<Analytical Method for Conductive Carbon>>

The conductive carbon in the active material coating section of the positive electrode active material and the conductive carbon as the conducting agent can be distinguished by the following analytical method.

For example, particles in the positive electrode active material layer are analyzed by a combination of transmission electron microscopy-electron energy loss spectroscopy (TEM-EELS), and particles having a carbon-derived peak around 290 eV only near the particle surface can be judged to be the positive electrode active material. On the other hand, particles having a carbon-derived peak inside the particles can be judged to be the conducting agent. In this context, “near the particle surface” means a region to the depth of 100 nm from the particle surface, while “inside” means an inner region positioned deeper than the “near the particle surface”.

As another method, the particles in the positive electrode active material layer are analyzed by Raman spectroscopy mapping, and particles showing carbon-derived G-band and D-band as well as a peak of the positive electrode active material-derived oxide crystals can be judged to be the positive electrode active material. On the other hand, particles showing only G-band and D-band can be judged to be the conducting agent.

As still another method, a cross section of the positive electrode active material layer is observed with scanning spread resistance microscope (SSRM). When the particle surface has a region with lower resistance than the inside of the particle, the region with lower resistance can be judged to be the conductive carbon present in the active material coating section. Other particles that are present isolatedly and have low resistance can be judged to be the conducting agent.

In this context, a trace amount of carbon considered to be an impurity and a trace amount of carbon unintentionally detached from the surface of the positive electrode active material during production are not judged to be the conducting agent.

Using any of these methods, it is possible to verify whether or not the conducting agent formed of carbon material is contained in the positive electrode active material layer.

### <Volume Density>

The volume density of the composite laminate 16 is preferably 2.2 to 2.7 g/cm³, more preferably 2.22 to 2.60 g/cm³, and even more preferably 2.24 to 2.50 g/cm³. When the volume density of the composite laminate 16 is not less than the lower limit, the volume capacity density can be increased, and the cycle characteristics can be improved. When the volume density of the composite laminate 16 is not more than the upper limit, there is no need to apply excessive pressure when producing the positive electrode 1. Therefore, deformation or damage to the positive electrode due to pressure can be further suppressed.

The volume density of the composite laminate 16 can be adjusted by a combination of the particle size of the positive electrode active material particles, the composition of the positive electrode active material layer 12, the thickness of the conductive layer 15, the pressure applied during the production of the positive electrode, and the like.

The volume density of the composite laminate 16 can be measured by, for example, the following measuring method.

The thicknesses of the positive electrode 1 and the positive electrode current collector metal body 14 are each measured with a micrometer, and the difference between these two thickness values is calculated as the thickness of the composite laminate 16. With respect to the thickness of the positive electrode 1 and the thickness of the positive electrode current collector metal body 14, each of these thickness values is an average value of the thickness values measured at five or more arbitrarily chosen points.

The mass of the measurement sample punched out from the positive electrode 1 so as to have a predetermined area is measured, from which the mass of the positive electrode current collector metal body 14 measured in advance is subtracted to calculate the mass of the composite laminate 16.

The volume density of the composite laminate 16 is calculated by the following formula (1).

Volume density (unit: g/cm³)=mass of composite laminate (unit: g)/[(thickness of composite laminate (unit: cm))×area of measurement sample (unit: cm²)] (1)

### <Volume Capacity Density>

The volume capacity density of the composite laminate 16 is 330 to 400 mAh/cm³, preferably 340 to 390 mAh/cm³, and more preferably 350 to 380 mAh/cm³. When the volume capacity density of the composite laminate 16 is not less than the lower limit, the energy density can be increased, and the output can be increased. When the volume capacity density of the composite laminate 16 is not more than the upper limit, the cycle characteristics can be improved.

The volume capacity density of the composite laminate 16 can be adjusted by the volume density of the composite laminate 16, the composition of the positive electrode active material layer 12, the thickness of the conductive layer 15, the pressure applied during the production of the positive electrode, and the like.

The volume capacity density of the composite laminate 16 can be measured by the following measurement method using, for example, a coin cell 100 shown in FIG. 2.

The coin cell 100 includes a battery case 101, a sealing plate 106, a gasket 105, a positive electrode 102, a separator 104, a negative electrode 103, and a non-aqueous electrolyte 108.

The battery case 101 is cup-shaped with an opening at the top. The sealing plate 106 is crimped to the battery case 101 via a gasket 105 made of an insulating material, sealing the opening of the battery case 101.

The positive electrode 102, the negative electrode 103, and the separator 104 are located inside the battery case 101. The positive electrode 102 and the negative electrode 103 face each other with the separator 104 in between. The non-aqueous electrolyte 108 is filled in the internal space surrounded by the battery case 101 and the sealing plate 106.

The production method of the coin cell 100 is described below.

The circular positive electrode 102 with a diameter of 14 mm, i.e., a size of φ14, is obtained. When the positive electrode to be evaluated has the composite laminate 16 on both sides, pure water is impregnated into one side to detach the composite laminate 16, and the positive electrode (hereinafter, may be referred to as a “single-sided positive electrode”) 102 having the composite laminate 16 only on one side is obtained. When the positive electrode to be evaluated has the composite laminate 16 only on one side, this is the single-sided positive electrode 102.

The mass of the single-sided positive electrode 102 is measured. The value obtained by subtracting the mass of the φ14 size positive electrode current collector metal body 14 from the measured mass of the single-sided positive electrode 102 is the mass A, i.e., the mass of the composite laminate 16. The mass of the φ14 size positive electrode current collector metal body 14 is determined by detaching the composite laminate 16 on both sides of the single-sided positive electrode 102 and measuring the mass.

A 2016-type coin cell is produced using the single-sided positive electrode 102.

The gasket 105 is placed in the battery case 101.

The single-sided positive electrode 102 is placed in the 2016-type case 101, which is a battery case with the gasket 105 placed in it. At this time, the composite laminate 16 is placed on top. An amount of non-aqueous electrolyte 108 that is sufficient to impregnate the single-sided positive electrode 102, for example 50 to 100 μL, is dropped onto the single-sided positive electrode 102. The non-aqueous electrolyte 108 is a liquid obtained by dissolving lithium hexafluorophosphate as an electrolyte at a concentration of 1 mol/L in a solvent that is a mixture of 3 parts by volume of ethylene carbonate and 7 parts by volume of diethyl carbonate.

A separator 104 made of polyethylene and 30 μm thick, punched into a circle with a diameter of 18 mm, i.e., φ18 size, is placed on the composite laminate 16 of the single-sided positive electrode 102, and an amount of electrolyte that sufficiently impregnates the separator 104, for example, 50 to 100 μL, is dropped onto the separator 104. A Li metal foil is punched into a circle with a diameter of 16 mm, i.e., φ16 size, to form the negative electrode 103. The negative electrode 103 is placed on the separator 104 so as to face the single-sided positive electrode 102 with the separator 104 interposed therebetween.

A sealing plate 106 is placed over the opening of the battery case 101, and the sealing plate 106 is crimped to the battery case 101 via the gasket 105 to seal it. The electric capacity (mAh/g) is then measured using the coin cell 100 in this manner.

The coin cell 100 is connected to a charge/discharge device, and constant current charging is performed at a current value of 0.1 mA until the potential (V vs Li/Li⁺) reaches 3.8 V. The potential is then maintained at 3.8 V, and constant voltage charging is performed until the current value reaches 0.01 mA, resulting in a fully charged state. After a rest period of 30 minutes has elapsed since the fully charged state was reached, discharging is performed at a current value of 0.1 mA until the potential reaches 2.0 V. The electrical capacity obtained during discharging is divided by the mass A to obtain the mass capacity density (mAh/g). The obtained mass capacity density is multiplied by the volume density (g/cm³) calculated using formula (1) above to obtain the volume capacity density (mAh/cm³).

### <Method for Producing Positive Electrode>

The method for producing the positive electrode 1 of the present embodiment includes a composition preparation step of preparing a positive electrode composition containing positive electrode active material particles, and a coating step of coating the positive electrode composition on the positive electrode current collector 11.

For example, a positive electrode composition containing positive electrode active material particles and a solvent is applied onto the conductive layer 15 of the positive electrode current collector 11 and dried to remove the solvent, thereby forming the positive electrode active material layer 12. As a result, a composite laminate 16, which is a laminate of the conductive layer 15 and the positive electrode active material layer 12, is provided on the positive electrode current collector metal body 14 to form the positive electrode 1.

The positive electrode composition may contain a conducting agent. The positive electrode composition may contain a binder. The positive electrode composition may contain a dispersant.

The positive electrode current collector 11, for examples, may be manufactured by forming a conductive layer 15 on one or both sides of a positive electrode current collector metal body 14, or may be purchased from the market.

The thickness of the positive electrode active material layer 12 can be adjusted by a method in which a layered body composed of the positive electrode current collector 11 and the positive electrode active material layer 12 formed thereon is placed between two flat plate jigs, then uniformly pressurized in the thickness direction of this layered body. For this purpose, for example, a method of pressurizing using a roll press can be used.

The solvent for the positive electrode composition is preferably a non-aqueous solvent. Examples of the solvent include alcohols such as methanol, ethanol, 1-propanol and 2-propanol; chain or cyclic amides such as N-methylpyrrolidone and N,N-dimethylformamide; and ketones such as acetone. With respect to these solvents, a single type thereof may be used individually or two or more types thereof may be used in combination.

### (Non-Aqueous Electrolyte Secondary Battery)

The non-aqueous electrolyte secondary battery 10 of the present embodiment shown in FIG. 3 includes a positive electrode 1 of the present embodiment, a negative electrode 3, and a non-aqueous electrolyte. The nonaqueous electrolyte secondary battery 10 may further include a separator 2. Reference numeral 5 in FIG. 3 denotes an outer casing.

In the present embodiment, the positive electrode 1 has a plate-shaped positive electrode current collector 11 and positive electrode active material layers 12 provided on both surfaces thereof. The positive electrode active material layer 12 is present on a part of each surface of the positive electrode current collector 11. The edge of the surface of the positive electrode current collector 11 is a positive electrode current collector exposed section 13, which is free of the positive electrode active material layer 12. The conductive layer 15 may be present on the surface of the positive electrode current collector exposed section 13, or the conductive layer 15 may not be present. That is, the positive electrode current collector metal body 14 may be exposed. A terminal tab (not shown) is electrically connected to an arbitrary portion of the positive electrode current collector exposed section 13.

The negative electrode 3 has a plate-shaped negative electrode current collector 31 and negative electrode active material layers 32 provided on both surfaces thereof. The negative electrode active material layer 32 is present on a part of each surface of the negative electrode current collector 31. The edge of the surface of the negative electrode current collector 31 is a negative electrode current collector exposed section 33, which is free of the negative electrode active material layer 32. A terminal tab (not shown) is electrically connected to an arbitrary portion of the negative electrode current collector exposed section 33.

The shapes of the positive electrode 1, the negative electrode 3 and the separator 2 are not particularly limited. For example, each of these may have a rectangular shape in a plan view.

FIG. 3 shows a representative example of a structure of the battery in which the negative electrode, the separator, the positive electrode, the separator, and the negative electrode are stacked in this order, but the number of electrodes can be altered as appropriate. The number of the positive electrode 1 may be one or more, and any number of positive electrodes 1 can be used depending on a desired battery capacity. The number of each of the negative electrode 3 and the separator 2 is larger by one sheet than the number of the positive electrode 1, and these are stacked so that the negative electrode 3 is located at the outermost layer.

### <Negative Electrode>

The negative electrode active material layer 32 includes a negative electrode active material. The negative electrode active material layer 32 may further includes a binder. The negative electrode active material layer 32 may further include a conducting agent. The shape of the negative electrode active material is preferably particulate.

For example, the negative electrode 3 can be produced by a method in which a negative electrode composition containing a negative electrode active material, a binder and a solvent is prepared, and coated on the negative electrode current collector 31, followed by drying to remove the solvent to thereby form a negative electrode active material layer 32. The negative electrode composition may contain a conducting agent.

Examples of the negative electrode active material and the conducting agent include carbon materials such as natural graphite and artificial graphite, lithium titanate, silicon, silicon monoxide, and silicon oxides. Examples of the carbon materials include graphite, graphene, hard carbon, Ketjen black, acetylene black, and carbon nanotube. With respect to each of the negative electrode active material and the conducting agent, a single type thereof may be used alone or two or more types thereof may be used in combination.

Examples of the material of the negative electrode current collector 31 include those listed above as examples of the material of the positive electrode current collector 11.

Examples of the binder in the negative electrode composition include polyacrylic acid, lithium polyacrylate, polyvinylidene fluoride, polyvinylidene fluoride-propylene hexafluoride copolymer, styrene-butadiene rubber, polyvinyl alcohol, polyethylene oxide, polyethylene glycol, carboxymethyl cellulose, polyacrylonitrile, polyimide, and the like. With respect to the binder, a single type thereof may be used alone or two or more types thereof may be used in combination.

Examples of the solvent in the negative electrode composition include water and organic solvents. Examples of the organic solvent include alcohols such as methanol, ethanol, 1-propanol and 2-propanol; chain or cyclic amides such as N-methylpyrrolidone and N,N-dimethylformamide; and ketones such as acetone. With respect to these solvents, a single type thereof may be used individually or two or more types thereof may be used in combination.

The sum of the amount of the negative electrode active material and the amount of the conducting agent with respect to the total mass of the negative electrode active material layer 32 is preferably 80.0 to 99.9% by mass, and more preferably 85.0 to 98.0% by mass.

### <Separator>

The separator 2 is disposed between the negative electrode 3 and the positive electrode 1 to prevent a short circuit or the like. The separator 2 may retain a non-aqueous electrolyte solution described below.

The separator 2 is not particularly limited, and examples thereof include a porous polymer film, a non-woven fabric, and glass fiber.

An insulating layer may be provided on one or both surfaces of the separator 2. The insulating layer is preferably a layer having a porous structure in which insulating fine particles are bonded with a binder for an insulating layer.

The thickness of the separator 2 is, for example, 5 to 50 μm.

The separator 2 may contain at least one of plasticizers, antioxidants, and flame retardants.

Examples of the antioxidant include phenolic antioxidants such as hinderedphenolic antioxidants, monophenolic antioxidants, bisphenolic antioxidants, and polyphenolic antioxidants; hinderedamine antioxidants; phosphorus antioxidants; sulfur antioxidants; benzotriazole antioxidants; benzophenone antioxidants; triazine antioxidants; and salicylate antioxidants. Among these, phenolic antioxidants and phosphorus antioxidants are preferable.

### <Non-Aqueous Electrolyte>

The non-aqueous electrolyte fills the space between the positive electrode 1 and the negative electrode 3. For example, any of known non-aqueous electrolytes used in lithium ion secondary batteries, electric double layer capacitors and the like can be used.

The non-aqueous electrolyte used in the manufacture of the non-aqueous electrolyte secondary battery 10 contains an organic solvent, an electrolyte, and an additive.

After manufacture, especially after initial charging, the non-aqueous electrolyte secondary battery 10 contains an organic solvent and an electrolyte, and may further contain residues or traces derived from the additives.

The organic solvent is preferably one having tolerance to high voltage. Examples of the organic solvent include polar solvents such as ethylene carbonate, propylene carbonate, dimethyl carbonate, diethyl carbonate, ethyl methyl carbonate, γ-butyrolactone, sulfolane, dimethyl sulfoxide, acetonitrile, dimethylformamide, dimethylacetamide, 1,2-dimethoxyethane, 1,2-diethoxyethane, tetrahydrofuran, 2-methyltetrahydrofuran, dioxolane, and methyl acetate, as well as mixtures of two or more of these polar solvents.

The electrolyte is not particularly limited, and examples thereof include lithium-containing salts such as lithium perchlorate, lithium hexafluorophosphate, lithium tetrafluoroborate, lithium hexafluoroarsenate, lithium trifluoroacetate, lithium bis(fluorosulfonyl)imide, and lithium bis(trifluoromethanesulfonyl)imide, or mixtures of two or more of these salts.

Examples of the additive include a compound A containing either or both of a sulfur atom and a nitrogen atom. The additive may be a single type or a combination of two or more types.

Examples of compound A include lithium bis(fluorosulfonyl)imide and lithium bis(trifluoromethanesulfonyl)imide.

### <Production Method of Non-Aqueous Electrolyte Secondary Battery>

The production method of the non-aqueous electrolyte secondary battery of the present embodiment includes a method of assembling a positive electrode, a separator, a negative electrode, a non-aqueous electrolyte, and an exterior body by a known method to obtain a non-aqueous electrolyte secondary battery.

An example of a production method of the non-aqueous electrolyte secondary battery of the present embodiment will be described. For example, an electrode laminate is produced in which the positive electrode 1 and the negative electrode 3 are alternately laminated with the separator 2 interposed therebetween. The electrode laminate is enclosed in the exterior body 5 such as an aluminum laminate bag. Next, a non-aqueous electrolyte is injected into the exterior body 5, and the exterior body 5 is sealed to obtain a non-aqueous electrolyte secondary battery.

The positive electrode of the present embodiment has a positive electrode current collector metal body and a composite laminate, the composite laminate has a conductive layer and a positive electrode active material layer containing positive electrode active material particles, the conductive layer contains conductive carbon, the positive electrode active material particles have an active material coating section containing conductive carbon, and the amount of conductive carbon in the composite laminate and the volume capacity density of the composite laminate are within specific ranges. By using such a positive electrode, it is possible to increase the energy density, reduce the resistance, and improve the cycle characteristics.

The non-aqueous electrolyte secondary battery of the present embodiment can be used as a lithium ion secondary battery for various purposes such as industrial use, consumer use, automobile use, and residential use.

The application of the non-aqueous electrolyte secondary battery of this embodiment is not particularly limited. For example, the battery can be used in a battery module configured by connecting a plurality of non-aqueous electrolyte secondary batteries in series or in parallel, a battery system including a plurality of electrically connected battery modules and a battery control system, and the like.

Examples of the battery system include battery packs, stationary storage battery systems, automobile power storage battery systems, automobile auxiliary storage battery systems, emergency power storage battery systems, and the like.

### EXAMPLES

Hereinbelow, the present invention will be described with reference to Examples which, however, should not be construed as limiting the present invention.

### (Evaluation Method)

### <Cycle Characteristics: Cycle Capacity Retention Rate>

Using a cell prepared so as to have a rated capacity of 1 Ah, the cycle capacity retention rate was evaluated according to the following steps (1) to (6). The evaluation was carried out at room temperature (25° C.).
(1) The obtained cell was charged at a constant current rate of 0.2 C (that is, 200 mA) and with a cut-off voltage of 3.6 V, and then charged at a constant voltage with a cut-off current rate of 0.05 C (that is, 20 mA).
(2) The cell was discharged for capacity confirmation at a constant current rate of 0.2 C and with a cut-off voltage of 2.5 V. The discharge capacity at this time was set as the reference capacity, and the reference capacity was set as the current value at 1 C rate (that is, 1,000 mA).
(3) After charging the cell at a constant current at a cell's 3.0 C rate (that is, 3000 mA) and with a cut-off voltage of 3.8 V, a 10-second pause was provided. From this state, the cell was discharged at 3.0 C rate and with a cut-off voltage of 2.0 V, and a 10-second pause was provided.
(4) The cycle test of (3) was repeated 1,000 times.
(5) After performing the same charging as in (1), the same capacity confirmation as in (2) was performed.
(6) The discharge capacity in the capacity confirmation measured in (5) was divided by the reference capacity before the cycle test to obtain a capacity retention after 1,000 cycles in terms of percentage, i.e., the cycle capacity retention rate (3C) in Table 1.

Further, instead of the 3.0 C rate, the above steps (1) to (6) were carried out at a 1.0 C rate, i.e., at 1000 mA, and this was taken as the cycle capacity retention rate (1C) in Table 1.

The cycle capacity retention rate was evaluated under an extremely high load condition of 3.0 C rate. That is, this condition makes the cycle capacity retention rate more likely to decrease than when evaluated under conditions such as a 0.5 C rate or a 1.0 C rate.

For example, non-patent document (Energies 2019, 12 (23), 4507 Electrochemical Impedance Spectroscopy on the Performance Degradation of LiFePO4/Graphite Lithium-Ion Battery Due to Charge-Discharge Cycling under Different C-Rates, https://mdpi-res.com/d_attachment/energies/energies-12-04507/article_deploy/energies-12-04507.pdf?version=1574846791) describes that the most severe deterioration over 1000 cycles occurs at a 2C rate rather than a 5C rate, and it is known that a rate of about 2.0 to 3.0 C is a condition under which the cycle capacity retention rate is likely to decrease.

### (Raw Materials Used)

### <Negative Electrode>

The negative electrode was produced by the following method.

100 parts by mass of artificial graphite as a negative electrode active material, 1.5 parts by mass of styrene-butadiene rubber as a binder, 1.5 parts by mass of carboxymethyl cellulose Na as a thickener, and water as a solvent were mixed, to thereby obtain a negative electrode composition having a solid content of 50% by mass.

The obtained negative electrode composition was applied onto both sides of an 8 μm-thick copper foil and vacuum dried at 100° C. Then, the resulting was pressure-pressed under a load of 2 kN to obtain a negative electrode sheet. The obtained negative electrode sheet was punched to obtain a negative electrode.

### <Positive Electrode Current Collector>

The positive electrode current collector was produced by the following method.

A slurry was obtained by mixing 100 parts by mass of carbon black, 40 parts by mass of polyvinylidene fluoride as a binder, and N-methylpyrrolidone as a solvent. The amount of N-methylpyrrolidone used was the amount required for applying the slurry.

The obtained slurry was applied to both sides of a 15 μm-thick aluminum foil, i.e., the positive current collector metal body, by a gravure method so as to allow the total thickness of the conductive layer on both sides of the positive current collector metal body after drying to was 2 μm, and then resulting product was dried to remove the solvent to obtain a positive electrode current collector. The conductive layers on both surfaces were formed so as to have the same amount of coating and the same thickness.

The obtained slurry was applied to both sides of a 15 μm-thick aluminum foil (positive electrode current collector main body) by a gravure method so as to allow the resulting current collector coating layers after drying (total of layers on both sides) to have a thickness of 2 μm, and dried to remove the solvent, thereby obtaining a positive electrode current collector. For Examples in which the obtained positive electrode current collector was used, the “Presence of conductive layer” column in the table is marked “Presence”.

Note that for Examples in which the “Presence of conductive layer” column in the table is marked “Absence”, a positive electrode current collector without a conductive layer was used, i.e., only the positive electrode current collector metal body was used.

### <Positive Electrode Active Material Particles>

As the positive electrode active material particles, coated particles (hereinafter referred to as “LFP coated particles”) having a core section made of lithium iron phosphate and an active material coating section made of carbon were used.

### <<Specifications of Positive Electrode Active Material Particles>>

Average particle size: 1.0 μm.
Carbon amount: Shown in table.
Coverage: Prepared to be 90% or more.

### <Others>

Carbon black or carbon nanotubes were used as the conducting agent. Impurities in the carbon black and carbon nanotubes were below the quantification limit, and the carbon amount can be considered to be 100% by mass.

Polyvinylidene fluoride was used as a binder.

N-methylpyrrolidone was used as a solvent.

### Examples 1 to 5, Comparative Examples 1 to 5

A positive electrode active material layer was formed by the following method. The positive electrode active material particles, the conducting agent (the amount shown in the table), 1% by mass of the binder, and N-methylpyrrolidone as a solvent were mixed in a mixer to obtain a positive electrode composition. The total amount of the positive electrode active material particles, the conductive agent, and the binder was 100% by mass. The amount of the solvent used was the amount required for applying the positive electrode composition. In each Example, the amount of the conductive agent was as shown in the table.

The obtained positive electrode composition was applied to both surfaces of the positive electrode current collector, and after pre-drying, the applied composition was vacuum-dried at 120° C. to form positive electrode active material layers. The total coating amount of the positive electrode composition on both sides of the positive electrode current collector was 20 mg/cm². The positive electrode active material layers on both surfaces of the positive electrode current collector were formed so as to have the same coating amount and the same thickness. The obtained laminate was pressure-pressed to obtain a positive electrode sheet.

The volume density of the composite laminate was adjusted by the pressing pressure of the pressure press. In the obtained positive electrode sheet, a composite laminate, which was a laminate of a conductive layer and a positive electrode active material layer, was formed on a positive electrode current collector metal body.

The obtained positive electrode sheet was punched to obtain a positive electrode.

With respect to the obtained positive electrode, the amount of the conductive carbon, volume density and volume capacity density of the composite laminate were measured, and the results are shown in the table.

A non-aqueous electrolyte secondary battery having a configuration shown in FIG. 3 was manufactured by the following method.

Lithium hexafluorophosphate as an electrolyte was dissolved at 1 mol/L in a solvent in which ethylene carbonate (hereinafter referred to as EC) and diethyl carbonate (hereinafter referred to as DEC) were mixed at a volume ratio, EC: DEC, of 3:7, to thereby prepare a non-aqueous electrolyte.

The positive electrode 1 obtained in each of the Examples and the negative electrode 3 were alternately interleaved through a separator 2 to prepare an electrode layered body with its outermost layer being the negative electrode 3. As a separator, a polyolefin film having a thickness of 15 μm was used.

In the step of producing the electrode layered body, the separator 2 and the positive electrode 1 were first stacked, and then the negative electrode 3 was stacked on the separator 2.

Terminal tabs were electrically connected to the positive electrode current collector exposed section 13 and the negative electrode current collector exposed section 33 in the electrode layered body, and the electrode layered body was put between aluminum laminate films while allowing the terminal tabs to protrude to the outside. Then, the resulting was laminate-processed and sealed at three sides.

To the resulting structure, a non-aqueous electrolyte was injected from one side left unsealed, and this one side was vacuum-sealed to manufacture a non-aqueous electrolyte secondary battery of each of the Examples (i.e., laminate cell).

The cycle retention rate of the obtained non-aqueous electrolyte secondary battery was measured, and the results are shown in the table.

TABLE 1

| | Carbon | | | | | | | |
|---|---|---|---|---|---|---|---|---|
| | amount of | | | | | | | |
| | positive | | | | | | | |
| | electrode | Carbon | | | | Volume | Cycle | Cycle |
| | active | amount of | | | Volume | density of | retention | retention |
| | material | composite | Conducting | Presence of | capacity | composite | rate | rate |
| | particles | laminate | agent | conductive | density | laminate | (3 C) | (1 C) |
| | [% by mass] | [% by mass] | [% by mass] | layer | [mAh/cm³] | [g/cm³] | [%] | [%] |
| Ex.1 | 2.5 | 2.5 | — | Presence | 332.2 | 2.25 | 94 | 99 |
| Ex.2 | 1.5 | 1.5 | — | Presence | 352.8 | 2.30 | 87 | — |
| Ex.3 | 1.5 | 1.5 | — | Presence | 377.7 | 2.40 | 88 | — |
| Ex.4 | 1.5 | 1.5 | — | Presence | 392.5 | 2.50 | 89 | — |
| Ex.5 | 1.5 | 2.0 | 0.5 | Presence | 331.4 | 2.25 | 84 | — |
| Comp. Ex.1 | 1.5 | 6.5 | 5 | Absence | 319.9 | 2.15 | 59 | — |
| Comp. Ex.2 | 2.5 | 2.5 | — | Absence | 345.6 | 2.25 | 23 | 97 |
| Comp. Ex.3 | 1.5 | 6.5 | 5 | Presence | 309.8 | 2.15 | 65 | — |
| Comp. Ex.4 | 1.5 | 1.5 | — | Presence | 298.3 | 1.90 | 79 | — |
| Comp. Ex.5 | 0.4 | 0.4 | — | Presence | 420.0 | 2.65 | 31 | — |

As shown in Table 1, in Examples 1 to 5 to which the present invention was applied, the cycle retention rate (3C) was 84% or more. Among them, the cycle retention rate (3C) of Examples 1 to 4, which did not contain a conducting agent, was 87% or more. Furthermore, the cycle retention rate (3C) of Example 1, which did not contain a conducting agent and had a high amount of conductive carbon, was 94%. That is, even when charging and discharging were repeated for 1000 cycles under a high rate condition of 3.0C rate, the capacity decrease was sufficiently suppressed, and extremely excellent cycle characteristics were achieved.

Comparative Examples 1 and 3, in which the amount of the conductive carbon in the composite laminate was 6.5 mass % and the volume capacity density was 309.8 to 319.9 mAh/cm³, had cycle retention rates (3C) of 59 to 65%.

Comparative Example 2, in which the amount of the conductive carbon in the composite laminate was 2.5 mass %, had a cycle retention rate (3C) of 23%.

Comparative Example 4, in which the volume capacity density of the composite laminate was 298.3 Ah/cm³, had a cycle retention rate (3C) of 79%.

Comparative Example 5, in which the volume capacity density of the composite laminate was 420.0 Ah/cm³, had a cycle retention rate (3C) of 31%.

Note that the cycle retention rate (1C) of Example 1 was 99%, and the cycle retention rate (1C) of Comparative Example 2 was 97%, and there was no significant difference in the cycle characteristics between Example 1 and Comparative Example 2 under the low rate condition of 1.0C rate. In other words, in the present invention, capacity decrease was sufficiently suppressed even after 1,000 charge/discharge cycles under high-rate conditions of 3.0 C rate, and it was found that extremely excellent cycle characteristics were achieved.

From these results, it was confirmed that the cycle retention rate can be improved by applying the present invention.

### EXPLANATION OF REFERENCE NUMERALS

1,102 Positive electrode
2,104 Separator
3,103 Negative electrode
4, 108 Non-aqueous electrolyte
5 Outer casing
10 Non-aqueous electrolyte secondary battery
11 Positive electrode current collector
12 Positive electrode active material layer
13 Positive electrode current collector exposed section
14 Positive electrode current collector metal body
15 Conductive layer
16 Composite laminate
31 Negative electrode current collector
32 Negative electrode active material layer
33 Negative electrode current collector exposed section
101 Battery case
105 Gasket
106 Sealing plate

1. A positive electrode for a non-aqueous electrolyte secondary battery, comprising a positive electrode current collector metal body and a composite laminate present on at least one surface of the positive electrode current collector metal body, wherein:
the composite laminate comprises a positive electrode active material layer and a conductive layer, wherein the conductive layer is present between the positive electrode current collector metal body and the positive electrode active material layer, and coats at least a part of the positive electrode current collector metal body,
the conductive layer comprises conductive carbon,
the positive electrode active material layer comprises one or more positive electrode active material particles,
at least a part of the positive electrode active material particles comprises a core section consisting of a positive electrode active material and an active material coating section coating at least a part of a surface of the core section,
the active material coating section comprises conductive carbon,
a total conductive carbon content of the composite laminate is 0.5 to 3.0% by mass with respect to a total mass of the composite laminate, and
a volume capacity density of the composite laminate is 330 to 400 mAh/cm³.

2. The positive electrode according to claim 1, wherein the positive electrode active material comprises a compound represented by a formula LiFeₓM₍₁₋ₓ₎PO₄, wherein 0≤x≤1, M is Co, Ni, Mn, Al, Ti or Zr.

3. The positive electrode according to claim 1, wherein a volume density of the composite laminate is 2.2 to 2.7 g/cm³.

4. A non-aqueous electrolyte secondary battery, comprising the positive electrode of claim 1, a negative electrode, and a non-aqueous electrolyte disposed between the positive electrode and the negative electrode.

5. A battery module or battery system comprising a plurality of the non-aqueous electrolyte secondary batteries of claim 4.

6. The positive electrode according to claim 2, wherein a volume density of the composite laminate is 2.2 to 2.7 g/cm³.

7. A non-aqueous electrolyte secondary battery, comprising the positive electrode of claim 2, a negative electrode, and a non-aqueous electrolyte disposed between the positive electrode and the negative electrode.

8. A non-aqueous electrolyte secondary battery, comprising the positive electrode of claim 3, a negative electrode, and a non-aqueous electrolyte disposed between the positive electrode and the negative electrode.

9. A non-aqueous electrolyte secondary battery, comprising the positive electrode of claim 6, a negative electrode, and a non-aqueous electrolyte disposed between the positive electrode and the negative electrode.

10. A battery module or battery system comprising a plurality of the non-aqueous electrolyte secondary batteries of claim 7.

11. A battery module or battery system comprising a plurality of the non-aqueous electrolyte secondary batteries of claim 8.

12. A battery module or battery system comprising a plurality of the non-aqueous electrolyte secondary batteries of claim 9.
